(19) United States
(12) Patent Application Publication
(10) Pub. No.: US 2007/0097390 A1
(43) Pub. Date: May 3, 2007

(54) Method for correcting cartridge color shifts for performing imaging with an imaging apparatus using a cartridge

(75) Inventors: Xuan-Chao Huang, Lexington, KY (US); Brant D. Nystrom, Lexington, KY (US); Richard L. Reel, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/263,387

(22) Filed: Oct. 31, 2005

(51) Int. Cl. H04N 1/60

(52) U.S. Cl. 358/1.9; 358/518

(57) ABSTRACT

A method for correcting cartridge color shifts for imaging with an imaging apparatus includes determining a spectral signature band for each colorant to yield a plurality of spectral signature bands; determining a minimum number of the spectral signature bands from the plurality of spectral signature bands to form a group of spectral signature bands that are applicable to all colorants of the plurality of colorants; determining a primary colorant profile for each colorant of the plurality of colorants of the cartridge based on the minimum number of the spectral signature bands; determining primary colorant shift data based on the primary colorant profile for each colorant and based on a standard cartridge primary colorant profile; estimating combined colorant shift data using the primary colorant shift data; and generating color correction data based on the combined colorant shift data for use in imaging with an imaging apparatus using the cartridge.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to imaging, and more particularly to a method for correcting cartridge color shifts for performing imaging with an imaging apparatus using a cartridge.

2. Description of the Related Art

Current imaging systems typically employ one or more replaceable cartridges of different types that are used to disperse a colorant on a print medium. For example, an ink jet printer may employ a CMY cartridge that prints full strength cyan, magenta, and yellow inks, and may also employ a Kcm cartridge that prints full strength black, dilute cyan, and dilute magenta inks.

The color shift between one cartridge and another is a common problem in color reproduction. When an imaging system reproduces colors using colorants from more than one type of cartridge, the reproduced color variations will be more complicated than using a single cartridge. For example, in an imaging system that uses a color cartridge with CMY inks (cyan, magenta, and yellow) and photo cartridge with Kcm inks (black, diluted cyan, and diluted magenta), called CMYKcm imaging system, the output color variation depends not only on the CMY cartridge color shifts but also on the Kcm cartridge color shifts. Correcting the composite color variations is more challenging than single cartridge color correction.

### SUMMARY OF THE INVENTION

The invention, in one exemplary embodiment, relates to a method for correcting cartridge color shifts for performing imaging with an imaging apparatus using a cartridge, the cartridge having a plurality of colorants. The method includes determining a spectral signature band for each colorant of the plurality of colorants to yield a plurality of spectral signature bands; determining a minimum number of the spectral signature bands from the plurality of spectral signature bands to form a group of spectral signature bands that are applicable to all colorants of the plurality of colorants; determining a primary colorant profile for each colorant of the plurality of colorants of the cartridge based on the minimum number of the spectral signature bands; determining primary colorant shift data based on the primary colorant profile for each colorant and based on a standard cartridge primary colorant profile; estimating combined colorant shift data using the primary colorant shift data; and generating color correction data based on the combined colorant shift data for use in imaging with an imaging apparatus using the cartridge.

The invention, in another exemplary embodiment, relates to a method for correcting cartridge color shifts for performing imaging with an imaging apparatus using a cartridge, the cartridge having a plurality of colorants. The method includes determining spectral signature data for each colorant of the plurality of colorants; selecting a spectral signature band common to all of the plurality of colorants; determining primary colorant shift data within the spectral signature band for the cartridge based on a standard cartridge primary colorant profile and based on the spectral signature band; and generating color correction data based on the primary colorant shift data for printing with an imaging apparatus using the cartridge.

The invention, in another exemplary embodiment, relates to a method for correcting cartridge color shifts for performing imaging with an imaging apparatus using a cartridge, the cartridge having a plurality of colorants. The method includes selecting a minimum spectral signature band common to all of the plurality of colorants; printing a test image for each colorant of the plurality of colorants individually using a varying amount of the colorant coverage values within a range of colorant coverage values for each colorant; measuring from the test image only a single reflectance value for each colorant coverage value of the varying amount of coverage values of the test image within the spectral signature band; determining primary colorant shift data based on the spectral signature band for the cartridge and based on a standard cartridge primary colorant profile and based on the measuring; and generating color correction data based on the primary colorant shift data for printing with an imaging apparatus using the cartridge.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system that utilizes the present invention;

FIG. 2 is a diagrammatic depiction of a colorspace converter accessing a composite color conversion lookup table in accordance with the present invention;

FIG. 3 is a flowchart that depicts method steps according to an embodiment of the present invention; and

FIGS. 4A-4C depict spectral distributions of yellow, magenta, and cyan inks, respectively, with different ink coverage on plain paper.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

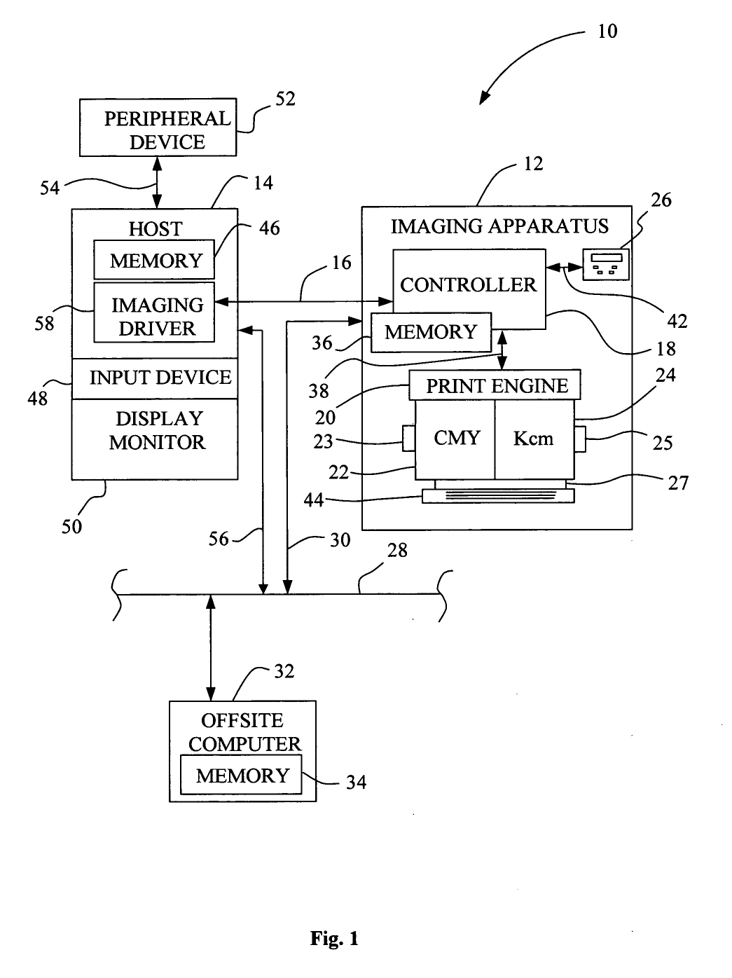

Referring now to the drawings, and particularly to FIG. 1, there is shown a diagrammatic depiction of an imaging system 10 embodying the present invention. In the embodiment depicted, imaging system 10 includes an imaging apparatus 12 and a host 14. Imaging apparatus 12 communicates with host 14 via a communications link 16. Alternatively, it is contemplated that imaging system 10 may be an imaging apparatus without a corresponding host computer, such as imaging apparatus 12 in the form of a stand-alone imaging apparatus, wherein the necessary functions of host 14 are performed by imaging apparatus 12 itself.

Imaging apparatus 12 may be, for example, an ink jet printer and/or copier, an electrophotographic printer and/or copier, or an all-in-one (AIO) unit that includes a printer, a scanner, and possibly a fax unit. Imaging apparatus 12 includes a controller 18, a print engine 20, one or more printing cartridges, such as a cartridge 22 having a cartridge memory 23 and a cartridge 24 having a cartridge memory 25, a user interface 26, and a sensor 27. Sensor 27 may be employed for measuring spectral data, such as reflectance data, for use in correcting cartridge color shifts in conjunction with the present invention.

Controller 18 is communicatively coupled to print engine 20. Print engine 20 is configured to mount cartridge 22 and cartridge 24, as well as to provide a communicative interface between controller 18, and cartridge memory 23 and cartridge memory 25. Imaging apparatus 12 has access to a network 28, for example, such as the Internet, via a communication line 30, and is capable of interfacing with other systems, such as an offsite computer 32 having an offsite memory 34, in order to transmit and/or receive data for use in carrying out its imaging functions. In the present embodiment, offsite computer 32 is a network server operated by, for example, a manufacturer, distributor and/or retailer of cartridge 22, cartridge 24, imaging apparatus 12, and/or imaging system 10.

Controller 18 includes a processor unit and an associated memory 36, and may be formed as one or more Application Specific Integrated Circuits (ASIC). Controller 18 may be a printer controller, a scanner controller, or may be a combined printer and scanner controller. Although controller 18 is depicted in imaging apparatus 12, alternatively, it is contemplated that all or a portion of controller 18 may reside in host 14. Controller 18 communicates with print engine 20, cartridge 22 and cartridge memory 23, and cartridge 24 and cartridge memory 25 via a communications link 38, and with user interface 26 via a communications link 42. Controller 18 serves to process print data, to operate print engine 20 during printing, and to perform color correction in accordance with the present invention.

In the context of the examples for imaging apparatus 12 given above, print engine 20 may be, for example, a color ink jet print engine or a color electrophotographic print engine, configured for forming an image on a substrate 44, which may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates cartridge 22 and cartridge 24 to eject ink droplets onto substrate 44 in order to reproduce text or images, etc. As an electrophotographic print engine, print engine 20 causes cartridge 22 and cartridge 24 to deposit toner onto substrate 44, which is then fused to substrate 44 by a fuser (not shown).

Host 14 may be, for example, a personal computer, including memory 46, an input device 48, such as a keyboard, and a display monitor 50. A peripheral device 52, such as a digital camera, is coupled to host 14 via a communication link 54. Host 14 further includes a processor, input/output (I/O) interfaces, and is connected to network 28 via a communication line 56, and hence, has access to offsite computer 32, including offsite memory 34. Memory 46 may be any or all of RAM, ROM, NVRAM, or any available type of computer memory, and may include one or more of a mass data storage device, such as a floppy drive, a hard drive, a CD and/or a DVD unit or other optical storage devices.

During operation, host 14 includes in its memory 46 a software program including program instructions that function as an imaging driver 58, e.g., printer/scanner driver software, for imaging apparatus 12. Imaging driver 58 is in communication with controller 18 of imaging apparatus 12 via communications link 16. Imaging driver 58 facilitates communication between imaging apparatus 12 and host 14, and provides formatted print data to imaging apparatus 12, and more particularly, to print engine 20. Although imaging driver 58 is disclosed as residing in memory 46 of host 14, it is contemplated that, alternatively, all or a portion of imaging driver 58 may be located in controller 18 of imaging apparatus 12. Although controller 18 is used to perform color correction in accordance with the present invention, it is alternatively contemplated that all or a portion of the color correction may be performed by imaging driver 58.

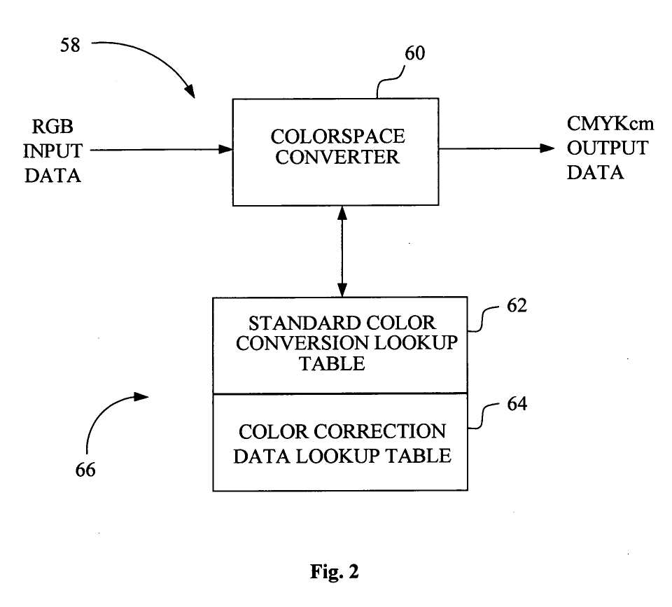

Referring now to FIG. 2, imaging driver 58 includes a colorspace converter 60. Although described herein as residing in imaging driver 58, colorspace converter 60 may be in the form of firmware or software, and may reside in either imaging driver 58 or controller 18. Alternatively, some portions of colorspace converter 60 may reside in imaging driver 58, while other portions reside in controller 18.

Colorspace converter 60 is used for converting color signals from a first colorspace, such as an RGB colorspace employed by display monitor 50 or a scanner, to a second colorspace, for example, CMYK (cyan, magenta, yellow, and black), which is used by print engine 20. The output of colorspace converter 60 may be used to provide multilevel printing, for example, CcMmYyKcm printing, which employs the following ink drop sizes/strengths/compositions: large undiluted cyan dye-based ink drops (“C”), small undiluted cyan dye-based drops (“c”), large undiluted magenta dye-based drops (“M”), small undiluted magenta dye-based ink drops (“m”), large undiluted yellow dye-based ink drops (“Y”), small undiluted yellow dye-based ink drops (“y”), undiluted black pigment-based ink drops (“K”), dilute cyan pigment-based ink drops (second occurrence in “CcMmYyKcm” of “c”), and dilute magenta pigment-based ink drops (second occurrence of “m”).

It will be understood that any reference to CMYK may include any combination of the CcMmYyKcm inks, and that any reference to CMY may include any combination of CcMmYy inks. For convenience, however, the present embodiment is described with respect to 6-level CMYKcm printing, wherein, for example, cartridge 22 is a CMY cartridge, and cartridge 24 is a Kcm photo cartridge.

Coupled to colorspace converter 60 are a standard color conversion lookup table 62 and a color correction data lookup table 64, which together define a composite color conversion lookup table 66. Standard color conversion lookup table 62 and composite color conversion lookup table 66 are multidimensional lookup tables having at least three dimensions, and include RGB values and CMYKcm values, wherein each CMYKcm output value corresponds to an RGB input value. Standard color conversion lookup table 62 and composite color conversion lookup table 66 may also include other data, such as spectral data, or other values or parameters for use in performing color conversion or color correction.

Standard color conversion lookup table 62 is the basic color conversion lookup table accessed by colorspace converter 60 of imaging apparatus 12 and imaging system 10 for performing color conversion. Color correction data lookup table 64 is specifically associated with the present invention method, forming an inventive component of the composite color conversion lookup table 66 used in the color conversion and color correction processes. Color correction data lookup table 64 includes color correction data that when employed in conjunction with standard color conversion lookup table 62, for example, as part of composite color conversion lookup table 66, provides color shift corrected color conversion data as output from colorspace converter 60. As shown in FIG. 2, for example, colorspace converter 60 converts input RBG color data for a displayed or scanned image into color shift corrected CMYKcm output data that may be printed by print engine 20 using composite color conversion lookup table 66, hence using color correction data lookup table 64 and standard color conversion lookup table 62.

Standard color conversion lookup table 62 incorporates color conversion data to support color conversion via composite color conversion lookup table 66 for multiple color formats and the multiple types of substrate 44. Color formats supported by standard color conversion lookup table 62 and color correction data lookup table 64, hence composite color conversion lookup table 66, include, for example, monochrome K output using true black ink only, CMYcm color output, wherein neutral colors are formed using process black, also known as composite black, produced by using a combination of CMYcm color inks, and CMYKcm color printing using a combination of full strength and dilute color inks and true black ink.

Color correction data lookup table 64 is a multidimensional lookup table having at least three dimensions that includes multidimensional color data for cartridge 22 and cartridge 24 expressed in a device independent CIELAB colorspace form. Alternatively, color correction data lookup table 64 may be in the form of multidimensional CIEXYZ device-independent colorspace data. However, the multidimensional color data of color correction data lookup table 64 may be expressed in any convenient device-dependent or device-independent colorspace. It will be understood that color correction data lookup table 64 may also include other data, such as spectral data, or other values or parameters for use in performing color conversion or color calibration.

Color correction data lookup table 64 is determined based on various data stored in a memory accessible by imaging apparatus 12. The data from which color correction data lookup table 64 is determined includes the “signature” colors of cartridge 22 and cartridge 24, such as, for example, the individual color output characteristics of the particular cartridge 22 and the particular cartridge 24 employed in imaging apparatus 12. The signature colors are determined based on spectral data as set forth in the following embodiments of the present invention.

The signature colors of a cartridge are a small set of colors that may be used to characterize the cartridge, or to classify the cartridge into a class of cartridges with similar color characteristics. In the present embodiment, signature color data for cartridge 22 and cartridge 24 are stored in a memory accessible by imaging apparatus 12, for example, cartridge memory 23 and cartridge memory 25, and read into memory 36 of controller 18, or, alternatively, read into the memory storing imaging driver 58. Alternatively, it is contemplated that the signature color data for cartridge 22 and cartridge 24 may be stored in offsite memory 34 of offsite computer 32, and retrieved by imaging system 10, e.g., by imaging apparatus 12 and/or host 14, and stored into memory 36 of controller 18, or, alternatively, the memory storing imaging driver 58.

In the embodiment described herein, the colorant increment data is arranged in color correction data lookup table 64 in an ordered format for access by colorspace converter 60, wherein the order of the data allows colorspace converter 60 to correlate the data of color correction data lookup table 64 with the similarly ordered data of standard color conversion lookup table 62 in defining composite color conversion lookup table 66.

Each of standard color conversion lookup table 62, color correction data lookup table 64 and composite color conversion lookup table 66 may alternatively be in the form of groups of polynomial functions capable of providing the same multidimensional output as if in the form of lookup tables.

The color shift from one cartridge to another is a common problem in color reproduction. In order to correct the color shift, the following method may be proposed: (a) measure cartridge signature colors on a first substrate (inexpensive substrate like plain paper) including combinations of different inks in the cartridge on the manufacturing line, and storing the signature color data in a first memory (e.g., cartridge memory). The signature color is expressed by
ξ=ƒ(φ) (Equation 1)
where ξ is the CIELAB tri-color (L*, a*, b*) where L* is lightness, a* redness-greenness, and b* yellowness-blueness, φ represents the colorant in the cartridge (e.g., φ=(C,M,Y) for a cartridge containing cyan, magenta, and yellow inks), ƒ denotes that ξ is a function of φ implemented as a lookup table or a group of polynomial functions. The next step would be (b) storing the signature color of a standard cartridge on the first substrate in a second memory (e.g., printer driver/firmware), which is expressed by
ξₛ=ƒₛ(φ) (Equation 2)
where subscript s denotes “standard cartridge.” Following, step (c) would include storing the signature color of the standard cartridge on a second substrate (e.g., glossy paper) in the second memory, which is expressed by
ξₛₚ=ƒₛₚ(φ) (Equation 3)
where subscript p denotes “paper being used by the user”. Finally, step (d) would include building on-line a color correction table based on Equations 1-3. An important part of the above method is obtaining cartridge signature colors on the manufacturing line (Equation 1).

It is desirable to simplify the above process and reduce the cost in obtaining cartridge signature colors on the manufacturing line. Thus, in accordance with the present invention, a method in which only color patches of individual inks (no ink combinations) are printed and only a single value (not tri-stimulus values, such as CIELAB data) for each color s patch is measured on the manufacturing line. This may reduce printing time, measuring time, data storage size, instrumentation expense, labor cost, and total cost. Additionally, the present invention may be applied onboard for individual printers, and thereby eliminate the process on the manufacturing line.

As set forth below, the present invention provides a method for measuring and correcting cartridge color shifts, including determining a minimum number of spectral signature bands for all individual colorants, e.g., inks, measuring a single value for each color patch based on the spectral signature band, determining primary colorant shift matrix, and estimating combined colorant shift matrix for color correction.

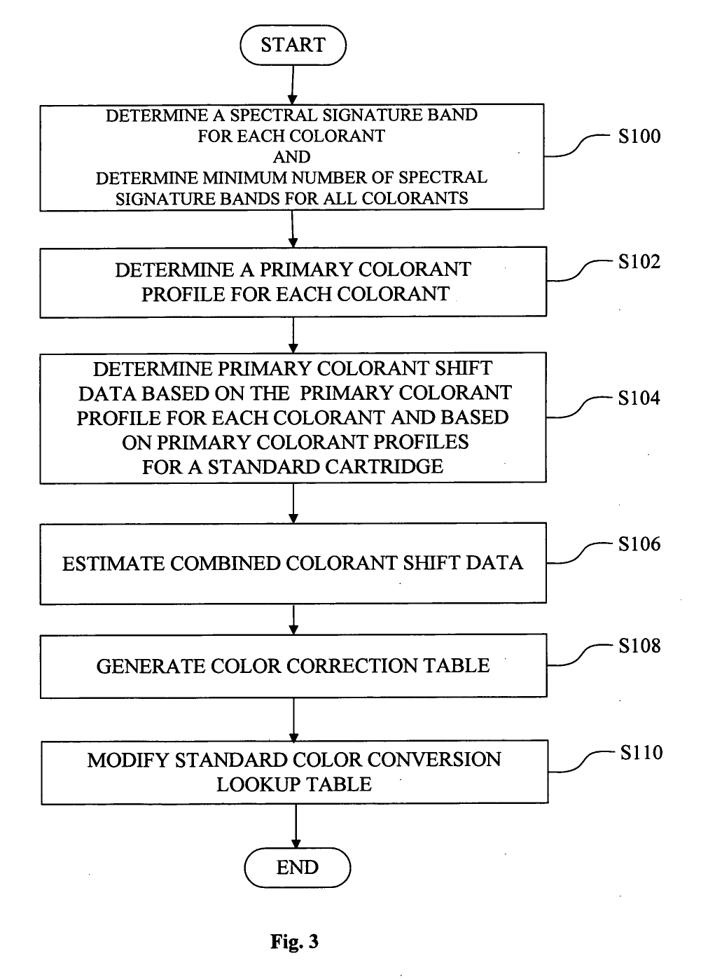

Referring now to FIG. 3, steps S100-S110 generally describe a method for correcting cartridge color shifts for performing imaging with an imaging apparatus, such as imaging apparatus 12, using a cartridge such as cartridge 22 and/or cartridge 24, each cartridge having a plurality of colorants, e.g., inks. Although the present embodiment is described with respect to two different cartridges, those skilled in the art would appreciate that the present invention is suited to the use of any number of cartridges, one or more, each having any number of colorants.

At step S100, a spectral signature band for each colorant of the plurality of colorants in cartridge 22 and cartridge 24 is determined, yielding a plurality of spectral signature bands, and the minimum number of spectral signature bands that form a group of spectral signature bands that is applicable to all colorants is determined. Preferably, the number of spectral signature bands that form the group is less than the total number of spectral signature bands, but the group has sufficient bandwidth to capture wavelengths from all of the colorants within an acceptable variation in relative magnitude of reflectance.

Step S100 includes printing a test image for each colorant (e.g., ink) individually, i.e., not a combination of inks. The test image is printed with a varying amount of colorant coverage values within a range of colorant coverage values for each ink, e.g., from 0 to 100% ink coverage. In the present embodiment, the test image is a plurality of color test patches, e.g., color patches, each of the plurality of test patches pertaining to a different colorant coverage value of the varying amount of colorant coverage values for each colorant, e.g., pertaining to a different ink coverage value in the range of 0 to 100% for the present embodiment.

A spectral signature band of a colorant is defined as a portion, e.g., bandwidth, of the spectral distribution in the visible electromagnetic spectrum of the ink under which the area changes significantly with a variation in the ink coverage on a substrate. Stated differently, a spectral signature band is selected as a bandwidth of wavelengths in the visible electromagnetic spectrum having an optimal variation in relative magnitude of reflectance for a corresponding range of colorant coverage values for each colorant of the cartridge. A variation in relative magnitude of reflectance is a change in reflectance corresponding with a change in colorant coverage, e.g., colorant coverage values ranging from 0% ink coverage to 100% ink coverage on a printed sheet. An optimal variation in relative magnitude of reflectance is a predetermined variation in magnitude of reflectance that is readily measured within the capability of the instrument used to measure reflectance, e.g., sensor 27. In the present embodiment, for example, the optimal variation in relative magnitude of reflectance is approximately 50. However, it will be understood that the present invention is not limited to a particular predetermined variation in magnitude of reflectance, but rather, the predetermined variation in magnitude of reflectance may be any value suitable for use in the imaging apparatus, for example, based on design and pricing parameters.

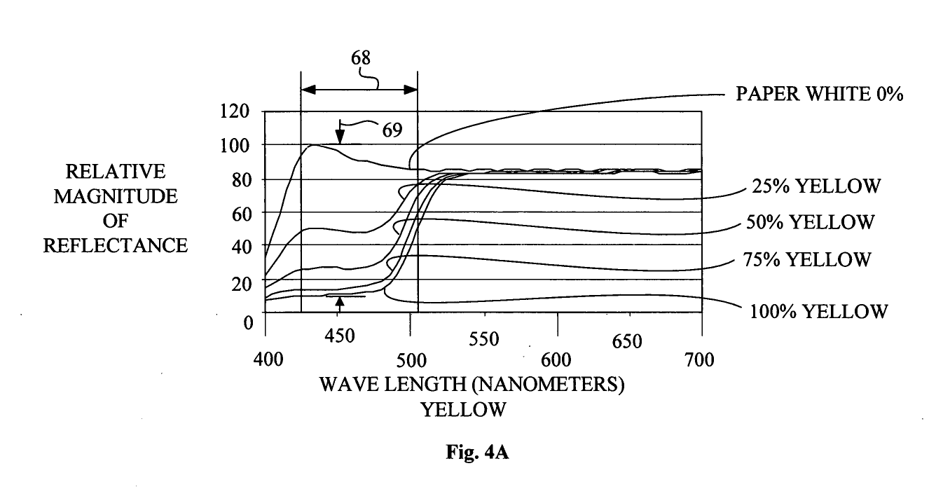

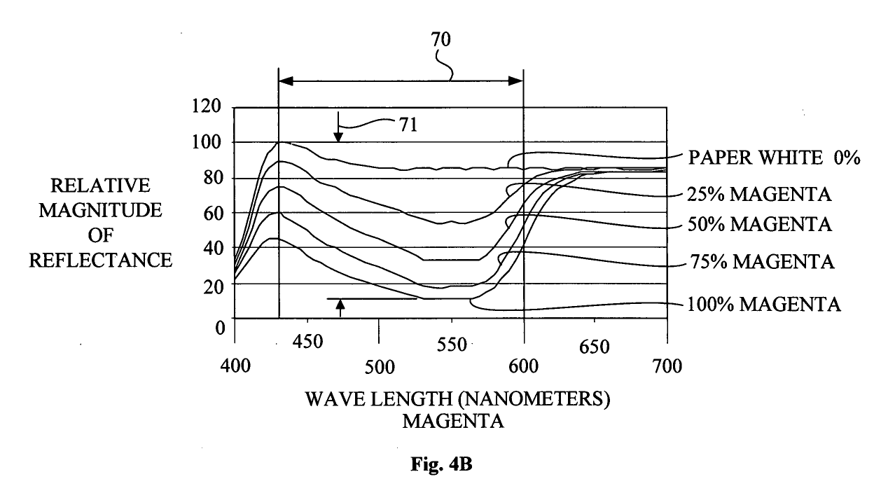

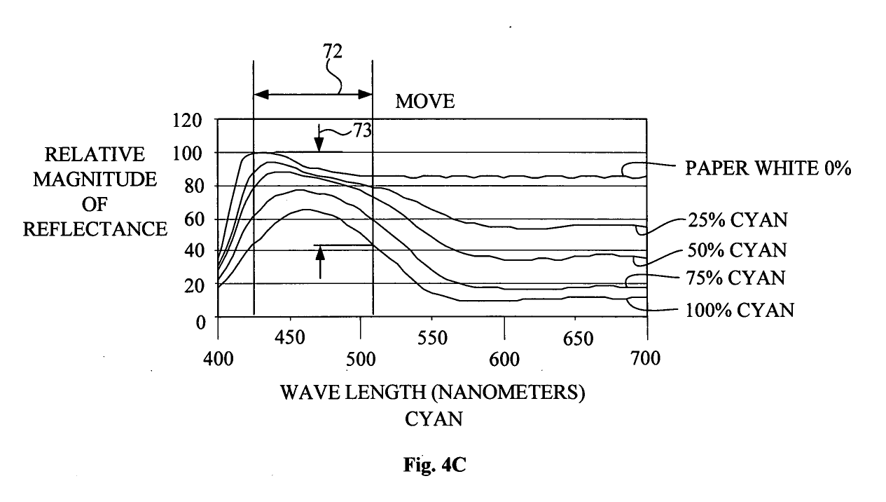

For example, referring now to FIGS. 4A-4C, the spectral distributions of yellow, magenta, and cyan inks with different ink coverages on a plain paper are illustrated. It is seen that the yellow ink spectral distribution of FIG. 4A change significantly with changes in ink coverage (percentage values of coverage, e.g., 0% or paper white, 25%, 75%, and 100% ink coverage) in the band between about 400 and 500 nm (e.g., a bandwidth of about 100 nanometers located between about 400 nanometers and about 500 nanometers), but there are almost no changes in the band between about 540 nm and about 700 nm. Therefore, the band between about 400 and 500 nm is defined as spectral signature band 68 for yellow ink, having variation in relative magnitude of reflectance 69 having a magnitude of approximately 90.

Similarly, it is seen that the magenta ink spectral distribution of FIG. 4B change significantly with changes in ink coverage in the band between about 430 nm and about 600 nm (e.g., a bandwidth of about 170 nm located between about 430 nm and about 600 nm), but there are almost no changes in the band between about 600 nm and 700 nm. Thus, the band between about 430 nm and 600 nm is defined as spectral signature band 70 for magenta ink, having variation in relative magnitude of reflectance 71 having a magnitude of approximately 90.

In the present exemplary embodiment, spectral signature band 72 for cyan is depicted in FIG. 4C as being from about 425 nm to about 510 nm, and having variation in relative magnitude of reflectance 73 with a value of approximately 56, as depicted in FIG. 4C. Although variation in relative magnitude of reflectance 73 of spectral signature band 72 for cyan is not as large as variation in relative magnitude of reflectance 69 for yellow and variation in relative magnitude of reflectance 71 for magenta, it is large enough for sufficiently accurate measurement using sensor 27.

Thus, it is seen from FIGS. 4A-4C that at least one spectral signature band may be found for each ink. If there exists one spectral signature band that is common to all of the individual inks contained in one cartridge or multiple cartridges of a printer, only one filter, or only one light source, whose spectra are mainly within the signature band may be required for sensor 27, which may allow the use of a lower cost sensor 27. Depending on the spectral properties of the inks, more than one signature band may be required, i.e., if there is not a reasonable amount of bandwidth in the spectral signature bands common to all inks. But the fewer bands required, the more cost of sensor 27 may be reduced.

Accordingly, the following procedure may be used to determine each spectral signature band and to determine the minimum number of spectral signature bands for all individual inks under consideration.

(1) For each of the inks under consideration, sample n points (n=5 was found to be acceptable) ranging from 0% to 100% of ink coverage and print out a color patch for each point. The total number (N) of color patches for m inks of one cartridge will be (only one paper-white patch (0% ink) is selected):
N=m(n−1)+1 (Equation 4)

(2) Select one standard cartridge and several (5 or more) non-standard cartridges covering the normally encountered color shift range. Print out N color patches for each of these cartridges. A standard cartridge is a hypothetical cartridge representing the average output of the particular type of cartridge, e.g., standard CMY cartridge representing the average cartridge 22, or standard Kcm cartridge representing the average cartridge 24.

(3) Measure spectral data for each color patch with a spectrophotometer covering wavelength from about 400 nm to about 700 nm and sampling one point per 10 nm interval, giving 31 data points per color patch. Also, measure CIELAB (L*, a*, b*) for each color patch. Comparing the spectral data of a non-standard cartridge to that of a standard cartridge will give the colorant shift matrix. This matrix is then used to estimate the CIELAB (L*, a*, b*) for the non-standard cartridge. The difference between the estimated and measured color values will be the error. If the spectral data in a band is sensitive to the colorant change, then the error will be small. Otherwise, the error may be large.

(4) Select a minimum bandwidth that is easily realizable for a filter or a LED (light emitting diode).

(5) For a given bandwidth, the band is moved along the measuring range (about 400 nm to about 700 nm) as shown in FIG. 4C.

(6) For each position of the band, error is computed using the spectral data within the given bandwidth. The error may be averaged for a group of inks. Each group may have 1, 2, . . . , and up to m inks. For example, there may be 6 groups for a CMY cartridge: C, M, Y, CM, MY, and CMY.

(7) Increase the bandwidth by a measuring interval (10 nm) and repeat steps 5 and 6.

(8) Select the minimum number of groups/bands (one group has one band that gives a minimum error when the band is moved along the measuring range), each of which has minimal or tolerable error. If several groups have a similar error, a higher priority is given to a group that has more number of inks. For the above example, if the CMY group has a band with similar error as the other groups, then it should be selected, since only one filter or one LED will be needed in sensor 27 for the 3 inks (i.e., the minimum number of spectral signature bands=1).

The inventors have tested pigmented cyan, magenta, and yellow inks using the above procedure, and the results are shown below in Table 1. It is seen that the CIELAB error (ΔE) ranges from 0.9 to 1.6 for the 6 groups: C, M, Y, CM, MY, and CMY. Therefore, it is feasible to use only one signature band (410-520 nm from the CMY group) that is common to the three C, M, and Y inks. This may allow a lower cost sensor 27 having a single filter/LED than a spectral sensor that employs three filters/LEDs for the three inks (one per ink).

TABLE 1
CIELAB color error vs. spectral signature band

| | | Signature Band | |
|---|---|---|---|
| No. | Inks in a group | (nm) | Average error (ΔE) |
| 1 | C | 520-560 | 1.3 |
| 2 | M | 430-550 | 0.9 |
| 3 | Y | 400-470 | 1.6 |
| 4 | C, M | 420-600 | 1.1 |
| 5 | M, Y | 400-470 | 1.3 |
| 6 | C, M, Y | 410-520 | 1.4 |

At step S102, a primary colorant profile is determined for each colorant, e.g., ink, of the plurality of colorants of the cartridge or cartridges, based on the minimum number of spectral signature bands, i.e., based on determining spectral data for the test image (which are color patches in the present embodiment) within the minimum number of spectral signature bands. Determining the spectral data includes measuring only a single value for each colorant coverage value of the varying amount of colorant coverage values of the test image within the minimum number of the spectral signature bands. In the present embodiment, the single value that is measured is a reflectance value measured from each color patch using sensor 27.

Once a spectral signature band for each ink is determined, a filter or LED is selected for sensor 27 based on the spectral signature bands. A broadband sensor 27 is then used to measure a single value for each color patch of the ink. The measured signal, referred to as a primary colorant profile, is expressed by:
yᵣ=g(x) (Equation 5)
where yᵣ is the signal proportional to the reflected light of a color patch (only one ink per color patch), subscript r denotes “reflected”, x is the digital count proportional to the ink percentage (for 8-bit value, x=0 for 0% ink, and x=255 for 100% ink), and g denotes the function relationship. When conducting simulation with spectral data measured with a spectrophotometer, g(x) will be the sum of the spectral data within the signature band.

The signal of the paper-white patch (i.e., 0% ink coverage) may be given by:
y_{rw}=g(0) (Equation 6)
where, subscript w denotes “white”. To remove the additive noise, the paper-white signal may be subtracted from that of the non-white color patch, giving an absorbed signal of the ink in a color patch:
yₐ=g(0)−g(x) (Equation 7)
where, subscript a denotes “absorbed”. If the noise of the paper-white patch is negligible compared to its signal (y_{rw}), then color patch signal may be normalized by the paper-white signal to minimize the impact of the instrument signal shifts with time due to aging, yielding:

$${y}_{na} = 1 - \frac{g ( x )}{g ( 0 )} \qquad ( Equation 8 )$$

where, subscript n denotes “normalized”.

At step S104, primary colorant shift data is determined based on the primary colorant profile for each ink, and based on a standard cartridge primary colorant profile for each corresponding ink, set forth as follows:

Let Equation 7 represent the signal from a non-standard cartridge on a first substrate (inexpensive substrate like plain paper), and the signal from a standard cartridge on the same substrate be denoted by:
yₛₐ=gₛ(0)−gₛ(x) (Equation 9)
where, subscript s denotes “standard cartridge”. The standard cartridge is determined and characterized in terms of CIELAB (L*, a*, b*) by the factory off the cartridge manufacturing line, e.g., based on average data from a plurality of cartridges. The standard cartridge signature color on the first substrate is expressed by Equation 2 and rewritten below:
ξₛ=ƒₛ(φ) (Equation 10)
which includes color values for both individual inks and their combinations. It is considered that the systematic (non-random) color shift of a non-standard cartridge may be compensated by shifting the colorant digital count (percentage of ink on the substrate). The shifted digital count is called effective colorant shift, or simply called colorant shift. If the colorant shift of a non-standard cartridge is known, then its CIELAB color shifts can be estimated using the standard cartridge signature color profile (Equation 10) by shifting the colorant variable (φ).

The following is a procedure to determine the primary colorant shifts (without ink combinations) based on the signals given in Equations 7 and 9.

(1) For a given primary colorant digital count xₛ, find yₛₐ in Equation 9.

(2) Make the left value yₐ of Equation 7 equal yₛₐ, find x using inverted computation.

(3) The primary colorant shift (Δxₚ) that is generally changed with the colorant digital count (x) is given by:
Δxₚ=x−xₛ (Equation 11)
where, subscripts denotes “primary ink” without ink combinations. The same procedure is applied to each of the m inks. Then a primary colorant shift matrix may be expressed by:
Δφₚ={Δxₚ_{ᵢ}}i=0,1, . . . ,(m−1) (Equation 12)

The primary colorant shift matrix Δφₚ plus φₛ (φ=φₛ+Δφₚ) may be entered to Equation 10 to compute the estimated CIELAB color values of the non-standard cartridge primary inks.

To verify the accuracy of the primary colorant shift matrix, the actual CIELAB color values of the same color patches used to measure the absorption signal ya may be measured with a spectrophotometer and used to compute the CIELAB color error (ΔE) against the estimated color values. The result is shown in Table 1, above. As set forth above using one signature band (about 410 nm to about 520 nm from the CMY group) for the C, M, and Y three inks is quite acceptable since the error is small. Thus, the minimum number of spectral signature bands takes the form of one minimum signature band common to all of the colorants, e.g., that substantially encompasses but does not exceed spectral signature bands 68, 70, and 72. Accordingly, in the present embodiment, the single reflectance value measured for each color patch is measured within the one minimum signature band to yield the primary colorant profile for each ink.

At step S106, combined colorant shift data is estimated using the primary colorant shift data, set forth as follows:

The effective shift of a colorant is generally different when it is alone (Δxₚ) than when it is combined with other colorants (Δx) due to the interaction of the diffraction and reflection between different colorants. It is assumed herein that combined colorant shift data is related to the primary colorant shift (without ink combination) in the following manner:
Δx=λ(Δxₚ)^{μ} (Equation 13)
where, λ and μ are variables (called ink interaction coefficients) which are theoretically the functions of the combined colorants (φ) and primary colorant shifts (Δφₚ), that is,
λ=ƒ_{λ}(φ,Δφₚ) (Equation 14)
and
μ=ƒ_{μ}(φ,Δφₚ) (Equation 15)

The procedure of estimating the ink interaction coefficients λ and μ in the present embodiment is as follows:

(1) For each of the inks under consideration, sample n points (n=5 was found to be acceptable) ranging from 0% to 100% of ink and print out a color patch for each point. The total number (N) of color patches for m inks of one cartridge will be calculated with Equation 4.

(2) Select one standard cartridge and several (15 or more) non-standard cartridges covering the normally encountered color shift range. Print out N color patches for each of these cartridges.

(3) Measure yₐ or yₛₐ (Equation 7 or 9) for each patch.

(4) Determine primary colorant shift (Δxₚ) (Equation 11) for each patch.

(5) For each cartridge, sample all combination points (n^{m}), print a color patch for each point, and measure CIELAB (L*, a*, b*) for each patch. This will yield measured color profiles for standard and non-standard cartridges (the non-standard cartridges representing those particular cartridges for which color shift correction is being performed).

(6) Set initial values of λ and μ for each ink at each of the n^{m} points (λ=μ=1.0 for points without ink combinations). Alternatively, λ and μ can be represented by polynomial functions and the coefficients can be initialized in this step.

(7) Compute the combined colorant shift (Δx) (Equation 13) for each ink at each of the n^{m} points.

(8) For each point, Interpolate the measured color profile of the standard cartridge with the sum of the point coordinates and the associated colorant shifts. This will give an estimated color profile for a non-standard cartridge.

(9) Compute and sum up the CIELAB color error between the estimated and measured color profiles of the non-standard cartridges.

(10) If the error reaches minimum or accepted level, output λ and μ as a lookup table or output polynomial coefficients. Otherwise, adjust parameters according to a pre-selected optimization procedure, and repeat steps 7-10.

With the ink interaction coefficients λ and μ determined, the combined colorant shift of each ink can be computed with Equation 13 to form a combined colorant shift matrix (Δφ) as follows:
Δφ={Δx₀,Δx₁, . . . ,Δxₘ₋₁} (Equation 16)

This matrix Δφ plus φₛ (φ=φₛ+Δφ) may be entered to the signature color profile of the standard cartridge (Equation 2 or 10) to compute the estimated signature color profile for the non-standard cartridge as shown in Equation 1.

At step S108, color correction data, e.g., color correction data lookup table 64, is generated based on the combined colorant shift data, for example, using equations 1-3, for use in imaging with imaging apparatus 12 using the cartridge, e.g., the particular cartridge 22 and/or cartridge 24 for which the above steps S100-S106 were performed.

At step S110, standard color conversion data, e.g., standard color conversion lookup table 62, is modified using color correction data lookup table 64 to form composite color conversion lookup table 66 for printing with imaging apparatus 12 using the particular cartridge 22 and/or cartridge 24.

To verify the feasibility of the above procedure, the present inventors tested 8 different standard CMY cartridges with one standard cartridge and one base color table. In order to simulate very broad color shifts compared to the standard cartridge, additional digital count percentages are added to several cases as shown in Table 2. For example, test case 4 is added by 20% cyan, that is, the cyan digital count of any color table grid will be added by 20% within the digital count limit (enhancing cyan channel by 20%). For each test case, each ink is sampled 5 points covering the whole range, resulting in a total of 5×5×5=125 combination points. One set of 125 color values is actually measured with a spectrophotometer. Another set of 125 color values is estimated using the procedure developed in the present invention (set λ=μ=1.0, g(x) in Equation 5 is obtained using the spectral data within the signature band from about 410 nm to about 520 nm for all C, M and Y inks). The CIELAB color error (ΔE) between the two sets of data is shown in Table II, below.

TABLE 2
CIELAB color error between estimated and measured data

| | Added | | |
|---|---|---|---|
| | colorants to a base | Average error | Average error |
| Non- | color table (simulating | measured with L* | measured with |
| standard | broad color shifts | for cyan & | signature band: |
| cartridge | compared to standard | magenta, b* for | 410-520 nm for |
| No. | cartridge). | yellow | all inks |
| 1 | | 1.5 | 1.4 |
| 2 | | 1.9 | 2.1 |
| 3 | | 1.6 | 2.5 |
| 4 | C: 20% | 1.8 | 1.9 |
| 5 | M: 10% | 1.8 | 1.9 |
| 6 | Y: 15% | 1.9 | 1.6 |
| 7 | M: 10%, Y: 15% | 1.5 | 1.7 |
| 8 | C: 20%, M: | 1.9 | 2.3 |
| | 10%, Y: 15% | | |

To further verify the above procedure, still another set of 125 color values is each test case in such a way that each primary color patch is measured with a spectrophotometer but only a single value is selected rather than tri-values: L* is selected for cyan and magenta patches, and b* for yellow patches. That is, g(x) in Equation 5 is replaced by L* for cyan and magenta, and by b* for yellow (set λ=μ=1.0). This estimation error is also shown in Table 2.

It is seen in Table 2 that the errors of the two estimation methods are very close. This is because L* is sensitive to the change of cyan or magenta and b* is sensitive to the change of yellow, whereas the total spectral response within the signature band from about 410 nm to about 520 nm is sensitive to the change of cyan, magenta, or yellow. The errors are quite acceptable in practice, since the error will be further reduced when the actual values of λ and μ are determined), it is felt that the present invention will be beneficial in industrial applications.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for correcting cartridge color shifts for performing imaging with an imaging apparatus using a cartridge, said cartridge having a plurality of colorants, the method comprising:
determining a spectral signature band for each colorant of said plurality of colorants to yield a plurality of spectral signature bands;
determining a minimum number of said spectral signature bands from said plurality of spectral signature bands to form a group of spectral signature bands that are applicable to all colorants of said plurality of colorants;
determining a primary colorant profile for each colorant of said plurality of colorants of said cartridge based on said minimum number of said spectral signature bands;
determining primary colorant shift data based on said primary colorant profile for said each colorant and based on a standard cartridge primary colorant profile;
estimating combined colorant shift data using said primary colorant shift data; and
generating color correction data based on said combined colorant shift data for use in imaging with an imaging apparatus using said cartridge.

2. The method of claim 1, wherein each said spectral signature band pertains to a bandwidth of wavelengths in the visible electromagnetic spectrum.

3. The method of claim 1, wherein each said spectral signature band is selected as a bandwidth of wavelengths in the visible electromagnetic spectrum having an optimal variation in relative magnitude of reflectance for a corresponding range of colorant coverage values for each said colorant of said cartridge.

4. The method of claim 1, wherein said imaging apparatus includes standard color conversion data, further comprising modifying said standard color conversion data using said color correction data for printing with said imaging apparatus using said cartridge.

5. The method of claim 1, wherein said determining said primary colorant profile includes:
printing a test image for said each colorant individually; and
determining spectral data for said test image within said minimum number of said spectral signature bands.

6. The method of claim 5, wherein said printing said test image includes printing said test image with a varying amount of colorant coverage values within a range of colorant coverage values for said each colorant.

7. The method of claim 6, wherein said determining said spectral data includes measuring only a single value for each colorant coverage value of said varying amount of said colorant coverage values of said test image within said minimum number of said spectral signature bands.

8. The method of claim 7, wherein said single value pertains to reflectance data.

9. The method of claim 7, wherein:
said minimum number of said signature bands is one minimum signature band common to said all colorants of said plurality of colorants; and
said single value is measured within said one minimum signature band to yield said primary colorant profile for said each colorant.

10. The method of claim 7, wherein said test image is a plurality of color test patches, each of said plurality of test patches pertaining to a different colorant coverage value of said varying amount of said colorant coverage values for said each colorant.

11. A method for correcting cartridge color shifts for performing imaging with an imaging apparatus using a cartridge, the cartridge having a plurality of colorants, the method comprising:
determining spectral signature data for each colorant of said plurality of colorants;
selecting a spectral signature band common to all of said plurality of colorants;
determining primary colorant shift data within said spectral signature band for said cartridge based on a standard cartridge primary colorant profile and based on said spectral signature band; and
generating color correction data based on said primary colorant shift data for printing with an imaging apparatus using said cartridge.

12. The method of claim 11, wherein:
said determining said primary colorant shift data includes determining a primary colorant profile for said each colorant of said plurality of colorants based on said spectral signature band, said primary colorant shift data being also based on said primary colorant profile for said each colorant; and
said generating said color correction data is also based on said primary colorant profile for said each colorant.

13. The method of claim 12, further comprising estimating combined colorant shift data using said primary colorant shift data, wherein said generating said color correction data is also based on said combined colorant shift data.

14. The method of claim 12, wherein said determining said primary colorant profile includes:
printing a test image for said each colorant individually; and
determining spectral data for said test image within said spectral signature band.

15. The method of claim 14, wherein said printing said test image includes printing said test image with a varying amount of colorant coverage values within a range of colorant coverage values for said each colorant.

16. The method of claim 15, wherein said determining said spectral data includes measuring only a single value for each colorant coverage value of said varying amount of said colorant coverage values of said test image within said spectral signature band.

17. The method of claim 16, wherein said single value pertains to reflectance data.

18. The method of claim 1 1, wherein each said signature band is selected as a bandwidth of wavelengths in the visible electromagnetic spectrum having an optimal variation in relative magnitude of reflectance for a corresponding range of colorant coverage values for each said colorant.

19. The method of claim 11, wherein said imaging apparatus includes standard color conversion data, further comprising modifying said standard color conversion data using said color correction data for printing with said imaging apparatus.

20. A method for correcting cartridge color shifts for performing imaging with an imaging apparatus using a cartridge, the cartridge having a plurality of colorants, the method comprising:
selecting a minimum spectral signature band common to all of said plurality of colorants;
printing a test image for each colorant of said plurality of colorants individually using a varying amount of said colorant coverage values within a range of colorant coverage values for said each colorant;
measuring from said test image only a single reflectance value for each colorant coverage value of said varying amount of coverage values of said test image within said spectral signature band;
determining primary colorant shift data based on said spectral signature band for said cartridge and based on a standard cartridge primary colorant profile and based on said measuring; and
generating color correction data based on said primary colorant shift data for printing with an imaging apparatus using said cartridge.
